(19) United States
(12) Patent Application Publication
(10) Pub. No.: US 2025/0336321 A1
(43) Pub. Date: Oct. 30, 2025

(54) INFORMATION PROCESSING APPARATUS AND CONTROL METHOD

(71) Applicant: Lenovo (Singapore) Pte. Ltd., Singapore (SG)

(72) Inventors: Yoshinori Ito, Kanagawa (JP); Yuichi Sone, Kanagawa (JP)

(73) Assignee: Lenovo (Singapore) Pte. Ltd., Singapore (SG)

(21) Appl. No.: 18/936,830

(22) Filed: Nov. 4, 2024

(30) Foreign Application Priority Data
Apr. 26, 2024 (JP) 2024-072150

(51) Int. Cl. G09G 3/00

(52) U.S. Cl. CPC G09G 3/035; G09G 2320/08; G09G 2340/045; G09G 2340/0464; G09G 2354/00

(57) ABSTRACT

An information processing apparatus includes: a memory which stores a program of an application; and a processor which executes the program of the application stored in the memory to perform control to display a window of the application in a screen area of a display. The processor performs: display change processing to change arrangement of the window inside the screen area using a display switching function selected from among a plurality of display switching functions to switch position and size of the window inside the screen area according to predetermined rules, display state holding processing to hold, for each of the plurality of display switching functions, the position and size of the window before being changed by the display change processing, and display restoration processing.

### CROSS-REFERENCE TO RELATED APPLICATIONS

This application claims priority to Japanese Patent Application No. 2023-072150 filed on Apr. 26, 2024, the contents of which are hereby incorporated herein by reference in their entirety.

### TECHNICAL FIELD

The present invention relates to an information processing apparatus and a control method.

### BACKGROUND

There are information processing apparatuses capable of splitting a screen area of a display into two or more display areas and displaying windows of applications and the like in each display area. For example, in Japanese Patent No. 7440672, there is disclosed an information processing apparatus equipped with a flexible display over a first chassis and a second chassis rotatable by a hinge mechanism to be able to switch between a one-screen mode using a screen area of the flexible display as one display area, and a two-screen mode using two display areas obtained by splitting the screen area into the two display areas when the first chassis and the second chassis become in a bent state or a flat state, or to switch to a half-screen mode when a physical keyboard is mounted on part of the screen area.

Thus, when switching among the one-screen mode, the two-screen mode, and the half-screen mode, the position and size of each application window is changed to a suitable position and size appropriately according to each screen mode. Further, in recent years, there are also information processing apparatuses equipped with a function capable of arranging a window selected with a user operation arbitrarily in any of two or more display areas obtained by splitting the screen area (a so-called snap function).

As described above, although there are plural functions for appropriately changing the position or the size of each application window in the screen area of the display, there is a desire to avoid respective functions to be influenced by one another when the position or the size of the application window is restored to the original position or the size by each of the functions.

### SUMMARY

Embodiments of the present invention provide an information processing apparatus and a control method wherein, in a case where there are plural functions to change the position or size of the application window appropriately in the screen area of the display, respective functions are avoided to be influenced by one another when the position or size of the application window is restored to the original position or size.

An information processing apparatus according to the one or more embodiments of the present invention includes: a memory which stores a program of an application; and a processor which executes the program of the application stored in the memory to perform control to display a window of the application in a screen area of a display, wherein the processor performs display change processing to change the arrangement of the window inside the screen area using a display switching function selected from among a plurality of display switching functions to switch the position and size of the window inside the screen area according to predetermined rules, display state holding processing to hold, for each of the plurality of display switching functions, the position and size of the window before being changed by the display change processing, and display restoration processing in which, upon restoration of at least either of the position and the size of the window changed by the display change processing using each of the plurality of display switching functions, at least either of the position and the size of the window is restored based on the position and size of the window held by the display switching function used when performing the display change processing.

The above information processing apparatus may be such that, among a first display switching function by which, when rearranging the window being arranged in the screen area, switching whether to rearrange the window by setting the screen area as one display area or to rearrange the window by splitting the screen area into a plurality of display areas is made, a second display switching function by which, when rearranging the window being arranged in the screen area, switching whether to rearrange the window by setting the entire screen area as a display area or to rearrange the window by setting part of the screen area as the display area is made, and a third display switching function to switch on which layout predetermined in the screen area a window selected from among windows being arranged in the screen area is rearranged, at least two display switching functions are included in the plurality of display switching functions.

The above information processing apparatus may further include a bendable display as the display, wherein the first display switching function is a function capable of switching whether to rearrange the window by setting the screen area as one display area or to rearrange the window by splitting the screen area into the plurality of display areas depending on whether the display is in a bent state or not.

The above information processing apparatus may also be such that the second display switching function is a function capable of switching whether to rearrange the window by setting the entire screen area as a display area or to rearrange the window by setting, as the display area, part of the screen area except for an area on which a physical keyboard is mounted using, as a trigger, whether or not the physical keyboard is mounted on the area as part of the screen area.

The above information processing apparatus may further be such that the third display switching function is a function capable of switching on which layer predetermined in the screen area the window selected from among the windows being arranged in the screen area is rearranged.

Further, a control method according to one or more embodiments of the present invention is a control method for an information processing apparatus including: a memory which stores a program of an application; and a processor which executes the program of the application stored in the memory to perform control to display a window of the application in a screen area of a display, the control method including: a display change step of causing the processor to change the arrangement of the window inside the screen area using a display switching function selected from among a plurality of display switching functions to switch the position and size of the window inside the screen area according to predetermined rules; a display state holding step of causing the processor to hold, for each of the plurality of display switching functions, the position and size of the window before being changed by the display change step; and a display restoration step in which, upon restoration of at least either of the position and the size of the window changed by the display change step using each of the plurality of display switching functions, the processor restores at least either of the position and the size of the window based on the position and size of the window held by the display switching function used when the display change step is performed.

One or more embodiments of the present invention can avoid functions to be influenced by one another when there are plural functions to change the position and size of a window of an application in a screen area of a display.

### BRIEF DESCRIPTION OF THE DRAWINGS

FIG. 1 is a perspective view illustrating the appearance of an information processing apparatus according to one or more embodiments.

FIG. 2 is a side view illustrating an example of the information processing apparatus in a bent state according to one or more embodiments.

FIG. 3 is a side view illustrating an example of the information processing apparatus in a flat state according to one or more embodiments.

FIG. 4 is a diagram illustrating specific examples of various display modes of the information processing apparatus according to one or more embodiments.

FIGS. 5A-5B are diagrams illustrating an example of display control when switching from a one-screen mode to a two-screen mode according to one or more embodiments.

FIGS. 6A-6B are diagrams illustrating an example of control from the one-screen mode to a half-screen mode according to one or more embodiments.

FIGS. 7A-7B are diagrams illustrating display examples of layout selection icons according to one or more embodiments.

FIG. 8 is a diagram illustrating an example of a configuration in which the information processing apparatus according to one or more embodiments is connected with an external display.

FIG. 9 is a diagram illustrating a display example of a display selection icon according to one or more embodiments.

FIG. 10 is a diagram illustrating a display example when an internal display is selected in the display selection icon according to one or more embodiments.

FIG. 11 is a diagram illustrating a display example when a layout (display area) is selected in a layout selection icon according to one or more embodiments.

FIG. 12 is a diagram illustrating a display example when the display position of a window is changed by ending a drag operation according to one or more embodiments.

FIG. 13 is a block diagram illustrating an example of the hardware configuration of the information processing apparatus according to one or more embodiments.

FIG. 14 is a block diagram illustrating an example of the functional configuration of the information processing apparatus according to one or more embodiments.

FIG. 15 is a flowchart illustrating an example of processing by a display switching function according to one or more embodiments.

### DETAILED DESCRIPTION

Embodiments of the present invention will be described below with reference to the accompanying drawings.

### [Appearance of Information Processing Apparatus]

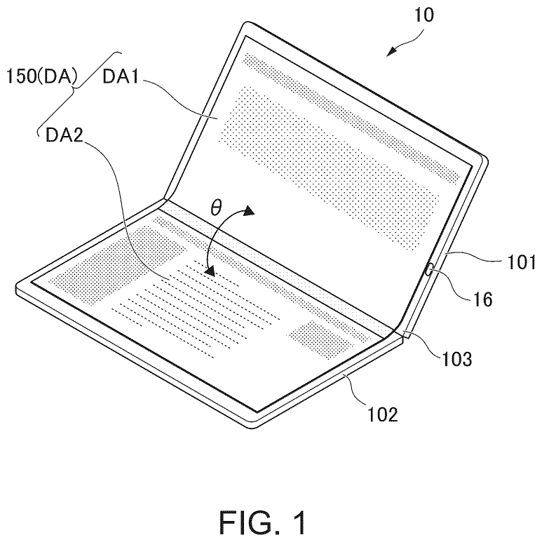

FIG. 1 is a perspective view illustrating the appearance of an information processing apparatus 10 according to one or more embodiments. The information processing apparatus 10 according to one or more embodiments is a clamshell (laptop) PC (Personal Computer). The information processing apparatus 10 includes a first chassis 101, a second chassis 102, and a hinge mechanism 103. The first chassis 101 and the second chassis 102 are chassis having a substantially rectangular plate shape (for example, a flat plate shape). One of the sides of the first chassis 101 and one of the sides of the second chassis 102 are joined (coupled) through the hinge mechanism 103, and the first chassis 101 and the second chassis 102 are rotatable relative to each other around a rotation axis formed by the hinge mechanism 103. A state where an open angle θ between the first chassis 101 and the second chassis 102 around the rotation axis is approximately 0° is a state where the first chassis 101 and the second chassis 102 overlap each other and are closed. The state where the first chassis 101 and the second chassis 102 are closed is called a “closed state.” Surfaces of the first chassis 101 and the second chassis 102 on the sides to face each other in the closed state are called respective “inner surfaces,” and surfaces opposite to the inner surfaces are called “outer surfaces.” The open angle θ can also be called an angle between the inner surface of the first chassis 101 and the inner surface of the second chassis 102. A state opposite to the closed state, where the first chassis 101 and the second chassis 102 are open, is called an “open state.” The open state is a state where the first chassis 101 and the second chassis 102 are rotated relative to each other until the open angle θ exceeds a preset threshold value (for example, 10°).

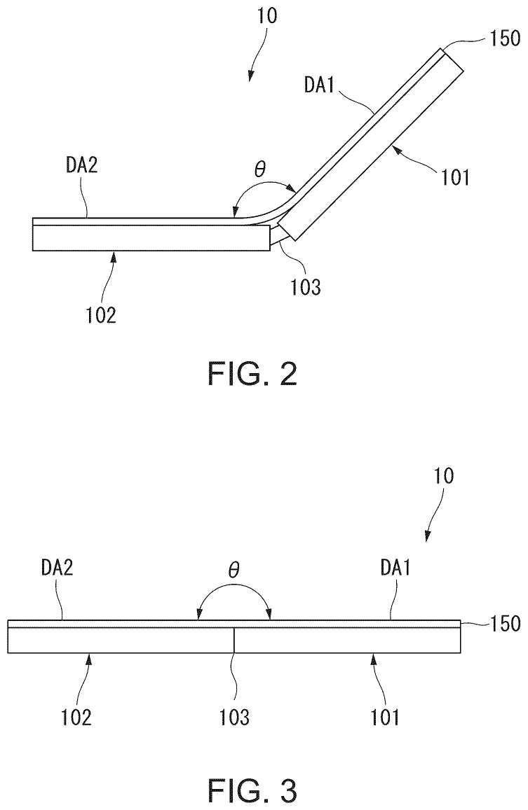

Further, the information processing apparatus 10 includes a camera 16 and a display 150. The camera 16 is provided on the inner surface of the first chassis 101. The display 150 is provided over the inner surface of the first chassis 101 and the inner surface of the second chassis 102. The camera 16 is provided, for example, in an outer part of a screen area of the display 150 on the inner surface of the first chassis 101 to be able to image a user and the like present on the side facing the display 150. The display 150 is a flexible display bendable according to the open angle θ by relative rotation of the first chassis 101 and the second chassis 102 (see FIG. 2 and FIG. 3). As the flexible display, an organic EL display or the like is used. The information processing apparatus 10 can control not only the display as a one-screen structure in which the entire screen area of the display 150 is used as one display area DA, but also the display as a two-screen structure in which the screen area of the display 150 is split into two display areas of a first display area DA1 and a second display area DA2. Here, the first display area DA1 and the second display area DA2 are display areas that do not overlap each other. It is assumed here that a display area corresponding to the inner surface side of the first chassis 101 in the screen area of the display 150 is the first display area DA1, and a display area corresponding to the inner surface side of the second chassis 102 is the second display area DA2. In the following, a display mode to control the display with the one-screen structure is called a “one-screen mode,” and a display mode to control the display with the two-screen structure is called a “two-screen mode.”

Note that a touch sensor is provided on the screen area of the display 150. The information processing apparatus 10 can detect touch operations on the screen area of the display 150. A user can visually recognize the display of the display 150 provided on the respective inner surfaces of the first chassis 101 and the second chassis 102, and perform touch operations on the display 150 by putting the information processing apparatus 10 into the open state, thus enabling the use of the information processing apparatus 10.

Next, usage forms and screen modes of the information processing apparatus 10 will be described in detail. First, the usage forms of the information processing apparatus 10 are classified by the open angle θ between the first chassis 101 and the second chassis 102 into a bent state in which the first chassis 101 and the second chassis 102 are bent (Bent form), and a flat state in which the first chassis 101 and the second chassis 102 are not bent (Flat form). In the following, the state where the first chassis 101 and the second chassis 102 are in a bent state (Bent form) is simply called the “bent state (Bent form),” and the flat state where the first chassis 101 and the second chassis 102 are not bent (Flat form) is simply called the “flat state (Flat form).” In the bent state (Bent form), the display 150 provided over the first chassis 101 and the second chassis 102 is also in the bent state. In the flat state (Flat form), the display 150 is also in the flat state.

FIG. 2 is a side view illustrating an example of the information processing apparatus 10 in the bent state (Bent form). The display 150 is arranged over (across the border between) the first chassis 101 and the second chassis 102. The screen area of the display 150 (the display area DA illustrated in FIG. 1) can be bent using a part corresponding to the hinge mechanism 103 as a crease, and on the border of this crease, a display area on the side of the first chassis 101 is illustrated as the first display area DA1, and a display area on the side of the second chassis 102 is illustrated as the second display area DA2. The display 150 is bent according to the rotation of (the open angle θ between) the first chassis 101 and the second chassis 102. The information processing apparatus 10 determines whether or not the state is the bent state (Bent form) according to the open angle θ. As an example, in a case of 10°<θ<170°, the information processing apparatus 10 determines that the state is the bent state (Bent form). This state corresponds to a usage form as a so-called clamshell mode or book mode.

FIG. 3 is a side view illustrating an example of the information processing apparatus 10 in the flat state (Flat form). The information processing apparatus 10 typically determines that the state is the flat state (Flat form) when the open angle θ is 180°, but as an example, the information processing apparatus 10 may also determine that the state is the flat state (Flat form) when the open angle θ is in a range of 170°≤θ≤180°. For example, when the open angle θ between the first chassis 101 and the second chassis 102 is 180°, the display 150 is also in the flat state. This state corresponds to a usage form as a so-called tablet mode.

### [Description of Display Modes]

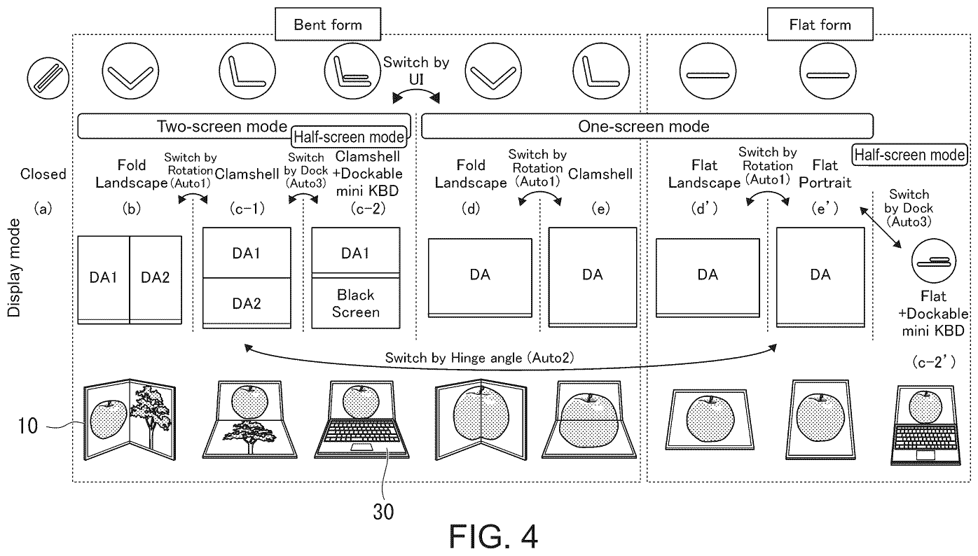

Referring next to FIG. 4, display modes by various usage forms of the information processing apparatus 10 will be described in detail.

FIG. 4 is a diagram illustrating specific examples of various display modes of the information processing apparatus 10 according to one or more embodiments. The display mode of the information processing apparatus 10 varies depending on the usage form classified by the open angle θ between the first chassis 101 and the second chassis 102, the posture (orientation) of the information processing apparatus 10, whether the mode is the one-screen mode or the two-screen mode, and the like. Note that one screen is also called a single screen, and two screens are also called spilt screens or dual screens.

Display mode (a) is a display mode when the first chassis 101 and the second chassis 102 are in the closed state (Closed) as the usage form. For example, in this closed state, the information processing apparatus 10 is in a standby state such as a sleep or hibernation state, and the display 150 is in a display-off state. This standby state such as the sleep or hibernation state corresponds, for example, to S3 or S4 as system power status defined in the ACPI (Advanced Configuration and Power Interface) specification.

Display mode (b) is a display mode in the bent state (Bent form) as the usage form, and the display mode is the two-screen mode in which the display is controlled by splitting the screen area of the display 150 into the two display areas of the first display area DA1 and the second display area DA2. Further, the orientation of the information processing apparatus 10 is an orientation in which the first display area DA1 and the second display area DA2 are lined up side by side in portrait orientation. The portrait orientation of the display areas means an orientation in which long sides of the four sides of each of rectangular display areas are vertical and short sides are horizontal. When the display areas are in portrait orientation, the display orientation is also portrait orientation, and the display is provided in such an orientation that the direction along the long sides corresponds to the up-down direction and the direction along the short sides corresponds to the left-right direction. This usage form is a usage form in which left and right screens correspond to left and right pages when a book is opened, which corresponds to the so-called book mode. Since this usage form is in the bent state (Bent form) and the display area obtained by combining the two display areas of the first display area DA1 and the second display area DA2 lined up side by side is horizontally long, it is also called “Fold Landscape.”

In this display mode (b), the information processing apparatus 10 is in a two-screen display mode in which the first display area DA1 on the left side is a primary screen and the second display area DA2 on the right side is a secondary screen, for example, in the normal operating state. Note that the correspondence relationship of the first display area DA1 and the second display area DA2 with the primary screen and the secondary screen in the display mode (b) may be reversed.

Like the display mode (b), display mode (c-1) is a display mode in the bent state (Bent form), and the display mode is the two-screen mode in which the display is controlled by splitting the screen area of the display 150 into the two display areas of the first display area DA1 and the second display area DA2, but the usage form is different from the display mode (b) in terms of the orientation of the information processing apparatus 10. The orientation of the information processing apparatus 10 is an orientation in which the first display area DA1 and the second display area DA2 are vertically lined up and down in landscape orientation. The landscape orientation of the display areas means an orientation in which long sides of the four sides of each of the rectangular display areas are horizontal and short sides are vertical. When the display areas are in landscape orientation, the display orientation is also landscape orientation, and the display is provided in such an orientation that the direction along the short sides corresponds to the up-down direction and the direction along the long sides corresponds to the left-right direction. This usage form is one of typical usage forms of a clamshell PC.

In this display mode (c-1), the information processing apparatus 10 is in the two-screen display mode in which the first display area DA1 is the primary screen and the second display area DA2 is the secondary screen, for example, in the normal operating state. Note that the correspondence relationship of the first display area DA1 and the second display area DA2 with the primary screen and the secondary screen in the display mode (c-1) may be reversed.

For example, the information processing apparatus 10 detects a change in the posture (orientation) of the information processing apparatus 10 to automatically switch from the display mode (b) to the display mode (c-1) or from the display mode (c-1) to the display mode (b) (Switch by Rotation). For example, since the display mode (c-1) is in such a state that the display 150 is rotated 90 degrees to the right from the state of the display mode (b) in FIG. 4, the information processing apparatus 10 switches to the display mode (c-1) when detecting the rotation of a predetermined angle (for example, 45 degrees) or more to the right from the state of the display mode (b). Further, since the display mode (b) is in such a state that the display 150 is rotated 90 degrees to the left from the state of the display mode (c-1) in FIG. 4, the information processing apparatus 10 switches to the display mode (b) when detecting the rotation of a predetermined angle (for example, 45 degrees) or more to the left from the state of the display mode (c-1).

Like the display mode (c-1), display mode (c-2) is in the bent state (Bent form) and the orientation of the information processing apparatus 10 is the same, but it is different in that an external keyboard 30 (Dockable mini KBD (KeyBoard)) connectable to the information processing apparatus 10 is connected. This usage form is in such a state that the physical keyboard 30 is connected in a general usage form of the clamshell PC. For example, the size of the keyboard 30 is almost equivalent to the size of the second display area DA2, and the keyboard 30 is configured to be mountable on the second display area DA2. As an example, magnets are provided inside the bottom (on the bottom edges) of the keyboard 30, and when the keyboard 30 is mounted on the second display area DA2, the magnets are attracted to metal parts of the inner surface edges of the second chassis 102 and fixed. Thus, the usage form becomes a usage form similar to that of a traditional clamshell PC with a physical keyboard originally provided thereon. Further, the information processing apparatus 10 and the keyboard 30 are connected, for example, via Bluetooth (registered trademark). In this display mode (c-2), since the second display area DA2 is made invisible, the information processing apparatus 10 controls the second display area DA2 to black display or display off. In other words, this display mode (c-2) is a display mode in which only half of the screen is enabled to provide a display (hereinafter called a “half-screen mode”), which corresponds to a one-screen mode using only the first display area DA1.

For example, when detecting the connection with the external keyboard in the state of the display mode (c-1), the information processing apparatus 10 automatically switches from the display mode (c-1) to the display mode (c-2) (Switch by Dock).

Like the display mode (b), display mode (d) is in the bent state (Bent form) and the orientation of the information processing apparatus 10 is the same, but it is different in that the display mode (d) is the one-screen mode in which the display is controlled using the entire screen area of the display 150 as one display area DA. Although this usage form is different from the display mode (b) in that the display mode is the one-screen mode, since it is in the bent state (Bent form) and the display area DA is horizontally long, this usage form is also called “Fold Landscape.” The display area DA is in landscape orientation, and the display orientation is also landscape orientation.

Here, switching between the one-screen mode and the two-screen mode in the bent state (Bent form) can be made, for example, with a user operation. For example, the information processing apparatus 10 displays an operating element as a UI (User Interface) capable of switching between the one-screen mode and the two-screen mode somewhere on the screen to switch from the display mode (b) to the display mode (d) based on an operation on the operating element (Switch by UI).

Like the display mode (c-1), display mode (e) is in the bent state (Bent form) and the orientation of the information processing apparatus 10 is the same, but it is different in that the display mode (e) is the one-screen mode in which the display is controlled using the entire screen area of the display 150 as one display area DA. This usage form is different from the display mode (c-1) in that the display mode (e) is the one-screen mode, but the display mode (e) corresponds to a usage form of the clamshell PC from the bent state (Bent form) and the orientation of the information processing apparatus 10. The display area DA is in portrait orientation and the display orientation is also portrait orientation.

For example, the information processing apparatus 10 detects a change in the posture (orientation) of the information processing apparatus 10 to automatically switch from the display mode (d) to the display mode (e), or from the display mode (e) to the display mode (d) (Switch by Rotation). For example, since the display mode (e) is in such a state that the display 150 is rotated 90 degrees to the right from the state of the display mode (d) in FIG. 4, the information processing apparatus 10 switches to the display mode (e) when detecting the rotation of a predetermined angle (for example, 45 degrees) or more to the right from the state of the display mode (d). Further, since the display mode (d) is in such a state that the display 150 is rotated 90 degrees to the left from the state of the display mode (e) in FIG. 4, the information processing apparatus 10 switches to the display mode (d) when detecting the rotation of a predetermined angle (for example, 45 degrees) or more to the left from the state of the display mode (e).

Like the display mode (d), display mode (d′) is the one-screen mode and the orientation of the information processing apparatus 10 is such an orientation that the display area DA is horizontally long, but it is different in that the information processing apparatus 10 is in the flat state (Flat form). The flat state (Flat form) is a state in which the open angle θ between the first chassis 101 and the second chassis 102 is approximately 180°. This usage form corresponds to the so-called tablet mode described with reference to FIG. 3. Since this usage form is in the flat state (Flat form) and the display area DA is horizontally long, it is also called “Flat Landscape.” This display mode (d′) is different from the display mode (d) only in the open angle θ between the first chassis 101 and the second chassis 102. Like in the display mode (d), the display area DA in the display mode (d′) is in landscape orientation and the display orientation is also landscape orientation.

Like the display mode (e), display mode (e′) is the one-screen mode and the orientation of the information processing apparatus 10 is such an orientation that the display area DA is vertically long, but it is different in that the information processing apparatus 10 is in the flat state (Flat form). Since this usage form is in the flat state (Flat form) and the display area DA is vertically long, it is also called “Flat Portrait.” This display mode (e′) is different from the display mode (e) only in the open angle θ between the first chassis 101 and the second chassis 102. Like in the display mode (e), the display area DA in the display mode (e′) is in portrait orientation and the display orientation is also portrait orientation.

For example, the information processing apparatus 10 detects a change in the posture (orientation) of the information processing apparatus 10 to automatically switch from the display mode (d′) to the display mode (e′), or from the display mode (e′) to the display mode (d′) (Switch by Rotation). For example, since the display mode (e′) is in such a state that the display 150 is rotated 90 degrees to the right from the state of the display mode (d′) in FIG. 4, the information processing apparatus 10 switches to the display mode (e′) when detecting the rotation of a predetermined angle (for example, 45 degrees) or more to the right from the state of the display mode (d′). Further, since the display mode (d′) is in such a state that the display 150 is rotated 90 degrees to the left from the state of the display mode (e′) in FIG. 4, the information processing apparatus 10 switches to the display mode (d′) when detecting the rotation of a predetermined angle (for example, 45 degrees) or more to the left from the state of the display mode (e′).

Here, switching between the one-screen mode and the two-screen mode in the flat state (Flat form) can be made, for example, with a user operation. For example, in the display mode (d′) and the display mode (e′), the information processing apparatus 10 displays the operating element as the UI capable of switching between the one-screen mode and the two-screen mode somewhere on the screen as described above, and it is also possible to switch to the two-screen mode while keeping the flat state (Flat form) by the user performing an operation on this operating element. For example, when switching to the two-screen mode from the state of the display mode (d′), the display state becomes similar to the display mode (b) in the flat state (Flat form). Further, when switching to the two-screen mode from the state of the display mode (e′), the display state becomes similar to the display mode (c-1) in the flat state (Flat form).

Further, when detecting the connection with the keyboard 30 in the state of the display mode (e′), the information processing apparatus 10 automatically switches from the display mode (e′) to display mode (c-2′) (Switch by Dock). The display mode (c-2′) is in the flat state (Flat form) but different from the display mode (c-2) only in the open angle θ between the first chassis 101 and the second chassis 102. In this display mode (c-2′), since the second display area DA2 becomes invisible by the keyboard, the information processing apparatus 10 controls the second display area DA2 to black display or display off. In other words, like the display mode (c-2), this display mode (c-2′) is the half-screen mode in which only half of the screen is enabled to provide a display.

Further, the information processing apparatus 10 can also switch automatically from the one-screen mode to the two-screen mode by detecting a change from the flat state (Flat form) to the bent state (Bent form) (Switch by Hinge angle). For example, when detecting a change to the bent state (Bent form) in the state of the display mode (d′) based on the open angle θ between the first chassis 101 and the second chassis 102, the information processing apparatus 10 automatically switches from the display mode (d′) to the display mode (b). Further, when detecting a change to the bent state (Bent form) in the state of the display mode (e′) based on the open angle θ between the first chassis 101 and the second chassis 102, the information processing apparatus 10 automatically switches from the display mode (e) to the display mode (c-1).

Here, a display mode switching function to switch whether to set the one-screen mode, in which the screen area of the display 150 is one display area, or the two-screen mode, in which the screen area of the display 150 is split into two display areas, as described with reference to FIG. 4 is called a “first display switching function.” Further, a display mode switching function to switch whether to set a full-screen mode, in which the entire screen area of the display 150 is the display area, or a half-screen mode, in which half of the screen area of the display 150 is the display area, using, as a trigger, whether or not the keyboard 30 is connected (mounted) is called a “second display switching function.” Note that, since the full-screen mode is the same as the one-screen mode, the full-screen mode is also called the one-screen mode below.

When switching to the one-screen mode using the first display switching function, the information processing apparatus 10 rearranges, in the screen area as one display area, windows being arranged in the screen area of the display 150. On the other hand, when switching to the two-screen mode using the first display switching function, the information processing apparatus 10 can use the display areas obtained by splitting the screen area into two display areas to rearrange the windows being arranged in the screen area of the display 150.

For example, when switching from the one-screen mode to the two-screen mode, the information processing apparatus 10 displays, in the first display area DA1, an active window of an app running in the one-screen mode. For example, when the transition to the two-screen mode is made, the information processing apparatus 10 maximizes and displays the active window, being displayed in the display area DA in the one-screen mode, in the entire first display area DA1 as the active window. Further, when the transition to the two-screen mode is made, the information processing apparatus 10 arranges windows as inactive windows in the one-screen mode on layers below the frontmost layer on which the active window is displayed in the first display area DA1 while maintaining the layer hierarchical relationship (the stacking order of windows) in the one-screen mode. Therefore, in the first display area DA1, the active window is maximized and displayed, and the inactive windows are not displayed though existing on the layers below the active window (invisible to the user).

Further, when switching from the one-screen mode to the two-screen mode, the information processing apparatus 10 generates a thumbnail image of a window as an inactive window in the one-screen mode, and displays a thumbnail window in the second display area DA2 (on the secondary screen). When there are two or more inactive windows, the information processing apparatus 10 displays, in the second display area DA2, a thumbnail window in which thumbnail images of the two or more inactive windows are lined up.

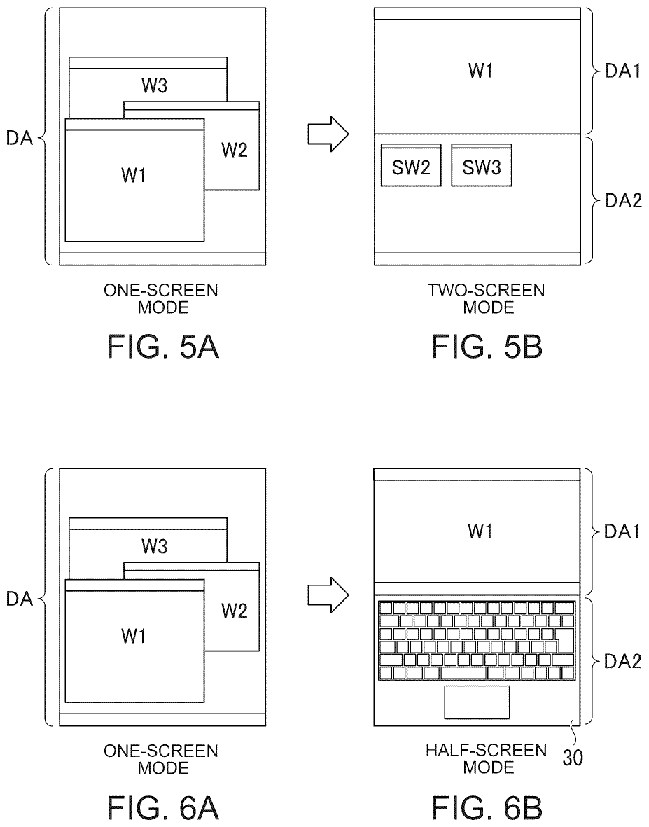

FIGS. 5A-5B are diagrams illustrating an example of display control when switching from the one-screen mode to the two-screen mode according to one or more embodiments. FIG. 5A illustrates a display example of the one-screen mode, and FIG. 5B illustrates a display example after switching to the two-screen mode. In the illustrated example, the number of windows of apps running in the one-screen mode is three. Here, three windows W1, W2, and W3 in the display area DA are illustrated. The window W1 is an active window arranged on the frontmost layer (the top layer). When switching from the one-screen mode to the two-screen mode, the window W1 is maximized and rearranged in the first display area DA1, and displayed as the active window.

Further, the windows W2 and W3 are rearranged on layers below the window W1 while maintaining the layer hierarchical relationship, and a thumbnail window in which thumbnail images SW2 and SW3 of the windows W2 and W3 are lined up is displayed in the second display area DA2. Note that, when the number of windows of apps running in the one-screen mode is four or more, the number of thumbnail images to be displayed in the second display area DA2 when switching to the two-screen mode is three or more.

When the user performs an operation to select any of thumbnail images being displayed in the second display area DA2, the information processing apparatus 10 maximizes and rearranges, for example, in the second display area DA2, a window corresponding to the selected thumbnail image, and displays the window as an active window.

Further, when switching to the full-screen mode using the second display switching function, the information processing apparatus 10 rearranges windows being arranged in the screen area of the display 150 using the entire screen area as a display area, while when switching to the half-screen mode using the second display switching function, the information processing apparatus 10 rearranges the windows being arranged in the screen area of the display 150 using half of the screen area as a display area.

FIGS. 6A-6B are diagrams illustrating an example of control from the one-screen mode to the half-screen mode according to one or more embodiments. In the one-screen mode illustrated in FIG. 6A, the information processing apparatus 10 controls the display using the display area DA as one display area, while when switching to the half-screen mode illustrated in FIG. 6B, the information processing apparatus 10 controls the display using only the first display area DA1 as a target for providing the display. Here, in the one-screen mode illustrated in FIG. 6A, the number of windows of running apps is three like in FIG. 5A, and the three windows W1, W2, and W3 are illustrated in the display area DA. The window W1 is an active window arranged on the frontmost layer (the top layer).

When the keyboard 30 is mounted on the second display area DA2 to switch from the one-screen mode to the half-screen mode, the window W1 is maximized and rearranged in the first display area DA1, and displayed as the active window. Note that the window W1 may also be displayed in the first display area DA1 in the same size without being maximized, or may be displayed in the first display area DA1 by resizing the window W1 not to stick out only when the window W1 sticks out of the first display area DA1 in the current size. The windows W2 and W3 are rearranged on layers below the window W1 while maintaining the layer hierarchical relationship. Further, the information processing apparatus 10 controls the second display area DA2 with the keyboard 30 mounted thereon to black display or display off.

Further, the information processing apparatus 10 has a function to rearrange a window of an application in a desired display area inside the screen area (a so-called snap function) in addition to the first display switching function and the second display switching function described above. This function is called a “third display switching function.” In the third display switching function, it is possible to switch (select) on which layer predetermined in the screen area a window selected from among windows being arranged in the screen area of the display 150 is rearranged.

For example, the information processing apparatus 10 displays an operating element as a UI (User Interface) capable of selecting in which display area inside the screen area of the display 150 the window is arranged (laid out), and displays the window in a display area selected by the user based on a user operation on the operating element. The UI capable of selecting a display area in which this window is arranged is called a “layout selection icon” below.

Note that the layout of display areas selectable with an operation on this layout selection icon is a layout in the entire screen area of the display 150 (the display area DA) regardless of whether the display mode is the one-screen mode or the two-screen mode described with reference to FIG. 4. Further, in the case of the half-screen mode, since an area (the first display area DA1) as half of the screen area of the display 150 is enabled as the screen area, the layout is for the first display area DA1.

### [Examples of Layout Selection Icons]

Next, specific examples of layout selection icons will be described.

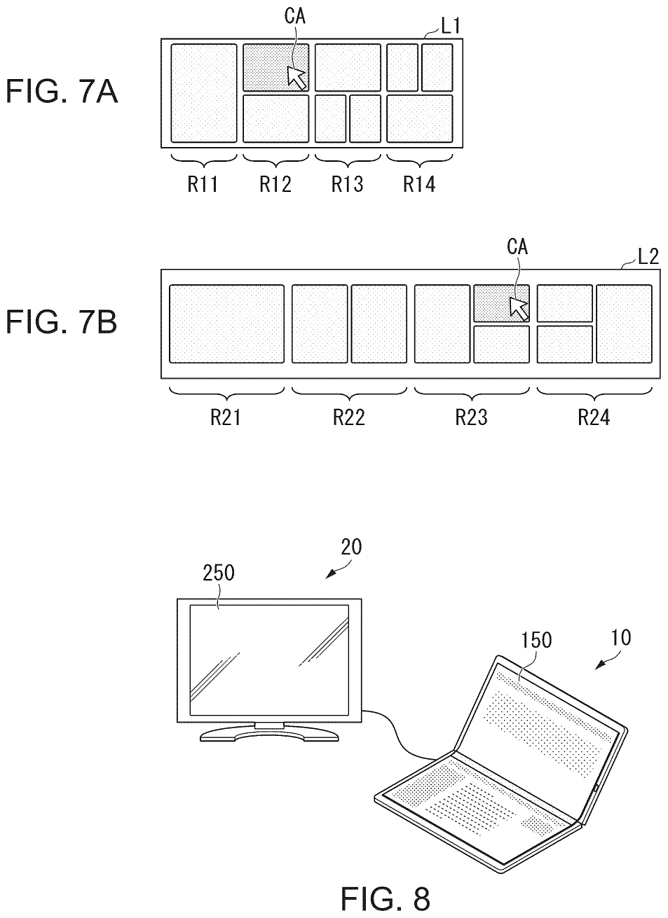

FIGS. 7A-7B are diagrams illustrating display examples of layout selection icons according to one or more embodiments. FIG. 7A illustrates an example of a layout selection icon L1 to be displayed when the usage form is “Portrait (or Clamshell)” (the display mode (c-1), the display mode (e), the display mode (e), or the like).

In the layout selection icon L1, a part indicated by symbol R11 is a layout using the entire screen area of the display 150 as one display area, where the entire screen area can be selected as a display area in which windows are arranged. A part indicated by symbol R12 is a layout in which the screen area is split into two upper and lower display areas to be able to select the upper display area or the lower display area inside the screen area as a display area in which the windows are arranged. Further, a part indicated by symbol R13 is a layout in which the lower display area obtained by splitting the screen area into the two upper and lower display areas is further split into two left and right display areas. A part indicated by symbol R14 is a layout in which the upper display area obtained by splitting the screen area into the two upper and lower display areas is further split into two left and right display areas. In the part indicated by the symbol R13 and the part indicated by the symbol R14, any of the three display areas can be selected as the display area in which the windows are arranged.

For example, when the usage form is “Portrait (or Clamshell),” the layout selection icon L1 is displayed by the user performing an operation to drag a window. As illustrated in FIG. 7A, when cursor CA with which the drag operation is being made is put on the upper area of the layout indicated by the symbol R12, where the screen area is split into the two display areas, the display area corresponding to the upper area is selected. The selected area in the layout selection icon L1 is changed in terms of the display mode (color, brightness, or the like). When the drag operation is ended, the window is displayed in the selected upper display area.

FIG. 7B illustrates an example of a layout selection icon L2 to be displayed when the usage form is “Landscape” (the display mode (b), the display mode (d), the display mode (d′), or the like).

In the layout selection icon L2, a part indicated by symbol R21 is a layout using the entire screen area of the display 150 as one display area, where the entire screen area can be selected as a display area in which windows are arranged. A part indicated by symbol R22 is a layout in which the screen area is split into two left and right display areas to be able to select the left display area or the right display area inside the screen area as a display area in which the windows are arranged. Further, a part indicated by symbol R23 and a part indicated by symbol R24 are layouts, in each of which the screen area is split into three display areas. The part indicated by the symbol R23 is a layout in which the right display area obtained by splitting the screen area into the two left and right display areas is further split into two up and down display areas. The part indicated by the symbol R24 is a layout in which the left display area obtained by splitting the screen area into the two left and right display areas is further split into two upper and lower display areas. In the part indicated by the symbol R23 and the part indicated by the symbol R24, any of the three display areas can be selected as the display area in which the windows are arranged.

For example, when the usage form is “Landscape,” the layout selection icon L2 is displayed by the user performing an operation to drag a window. As illustrated in FIG. 7B, when cursor CA with which the drag operation is being made is put on the upper area on the right side of the layout indicated by the symbol R23, where the screen area is split into the three display areas, the display area corresponding to the upper area on the right side is selected. The selected area in the layout selection icon L2 is changed in terms of the display mode (color, brightness, or the like). When the drag operation is ended, the window is displayed in the selected upper display area on the right side.

[Connection Configuration with External Display]

Further, the information processing apparatus 10 can be used by being connected with an external display.

FIG. 8 is a diagram illustrating an example of a configuration in which the information processing apparatus 10 according to one or more embodiments is connected with an external display. The information processing apparatus 10 is connected with an external display device 20. As the connection method, any connection method using HDMI (registered trademark), USB Type-C, a display port, or the like can be applied. Note that the information processing apparatus 10 may also be connected wirelessly with the external display device 20. The external display device 20 is configured to include a display 250 as the external display. The display 150 of the information processing apparatus 10 different from the external display is an internal display.

When the information processing apparatus 10 is connected with the external display device 20 to control displays for two or more screen areas (two or more screen areas that do not overlap each other) of the internal display and the external display, the information processing apparatus 10 can display windows in both of the screen area of the internal display and the screen area of the external display using the layout selection icons described with reference to FIGS. 7A-7B.

For example, the information processing apparatus 10 can display a window(s) being displayed in the screen area of the internal display not only in any of display areas on each layout inside the screen area of the internal display, but also in any of display areas on each layout of the external display. Similarly, the information processing apparatus 10 can display a window(s) being displayed in the screen area of the external display not only in any of display areas on each layout of the external display, but also in any of display areas on each layout in the screen area of the internal display.

When the information processing apparatus 10 is connected with the external display device 20, the information processing apparatus 10 displays a UI as an operating element for selecting whether either of the internal display and the external display is set as a screen area of a window display destination before a layout selection icon illustrated in FIGS. 7A-7B is displayed. This UI is called a “display selection icon” below.

### [Example of Display Selection Icon]

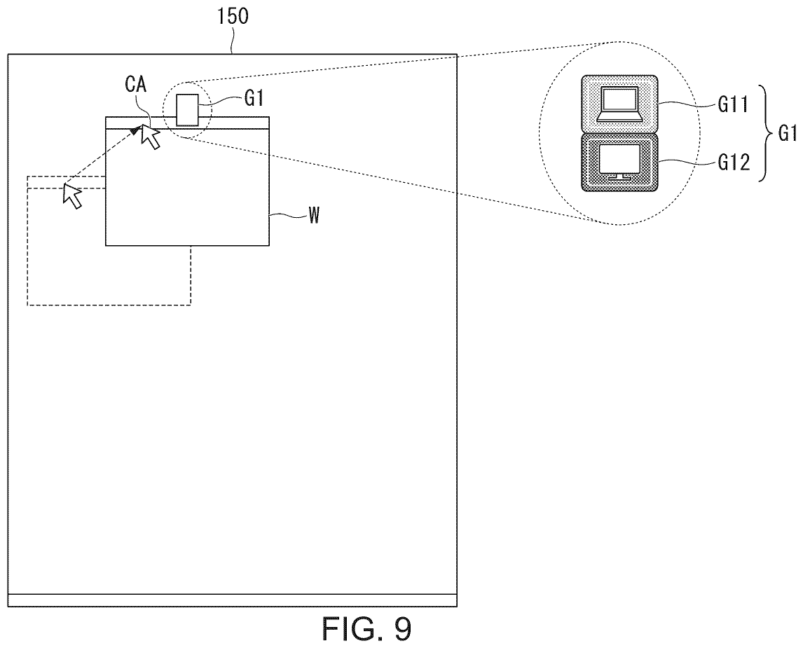

FIG. 9 is a diagram illustrating a display example of the display selection icon according to one or more embodiments. When a drag operation of window W being displayed on the internal display (display 150) or the external display (display 250) is started, a display selection icon G1 is displayed near the position of the cursor CA with which the drag operation is made. FIG. 9 illustrates an example when the drag operation of the window W being displayed on the internal display (display 150) is started. The display position of this display selection icon G1 remains unchanged even when the cursor CA is moved by the drag operation.

In the display selection icon G1, an internal display icon G11 corresponding to the screen area of the internal display and an external display icon G12 corresponding to the screen area of the external display are contained. The internal display icon G11 and the external display icon G12 are displayed in different designs (different design and pictorial patterns) that imitate the respective display types. In other words, the internal display icon G11 is designed to imitate the internal display provided in the information processing apparatus 10 (for example, a laptop PC). On the other hand, the external display icon G12 is designed to imitate the shape of the external display device 20. Thus, when selecting the display (screen area) as a display destination using the display selection icon G1, since the user can intuitively understand which icon is to select the internal display and which icon is to select the external display, operability is good.

Further, the internal display icon G11 and the external display icon G12 are different in terms of the display mode (for example, icon color (background color)) depending on whether or not it is the icon corresponding to the screen area in which the drag operation is started. For example, in the illustrated example, the background color of the internal display icon G11 corresponding to the screen area in which the drag operation is started is blue, but the background color of the external display icon G12 outside the screen area in which the drag operation is started is gray.

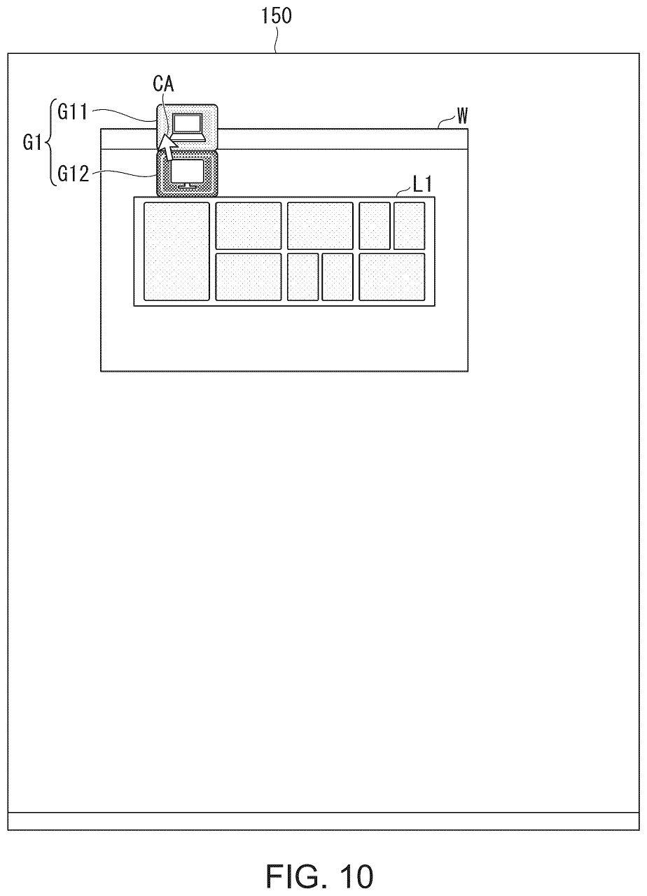

FIG. 10 is a diagram illustrating a display example when the internal display is selected in the display selection icon according to one or more embodiments. As illustrated in FIG. 10, the cursor CA with which the drag operation is being made is put on (hovering over) the internal display icon G11, the internal display is selected. Note that, when the cursor CA with which the drag operation is being made is put on (hovering over) the external display icon G12, the external display is selected.

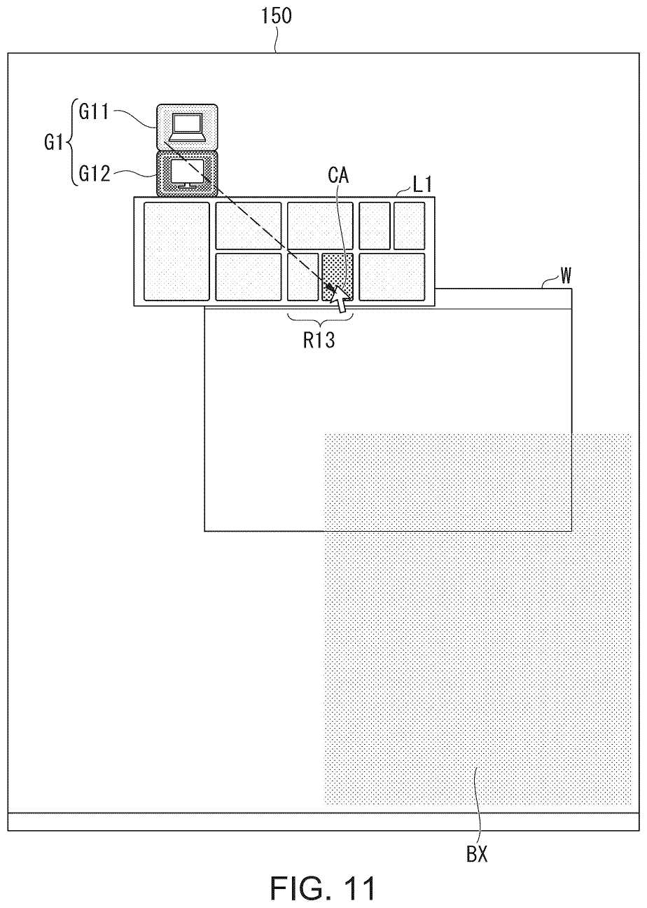

FIG. 11 is a diagram illustrating a display example when a layout (display area) is selected in a layout selection icon according to one or more embodiments. As illustrated in FIG. 11, when the cursor CA put on the internal display icon G11 by the drag operation on the window W is continuously dragged and put on any of display areas contained in the layout selection icon L1, the display area on which the cursor CA is put can be selected.

In the illustrated example, the bottom right display area is selected by putting the cursor CA, with which the drag operation is being made, on the bottom right display area among the three display areas indicated by the symbol R13 in the layout selection icon L1. This results in displaying display information, indicating that the display area is selected, in the bottom right display area (the area corresponding to the selected display area) inside the screen area of the internal display (display 150). For example, translucent display information (translucent box BX) indicative of the area corresponding to the selected display area is displayed. Thus, the user understands the selected display area (the area as the display destination of the window W on which the drag operation is being made) intuitively and easily.

Here, when the drag operation is ended in such a state that the cursor CA with which the drag operation is being made is put on any of the display areas contained in the layout selection icon L1 or L2, the display selection and the layout (display area) selection are confirmed, and the display position of the window W, on which the drag operation was being made, is changed into the selected display area inside the screen area of the display.

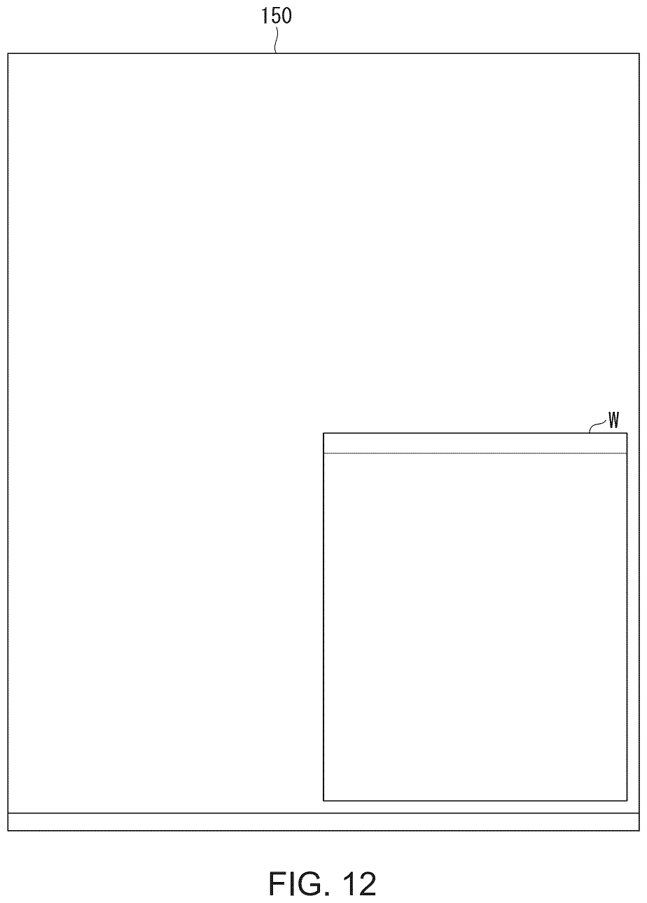

FIG. 12 is a diagram illustrating a display example when the display position of the window is changed by ending the drag operation according to one or more embodiments. For example, when the drag operation is ended in such a state that the internal display is selected and the cursor CA with which the drag operation was being made is put on the bottom right display area among the three display areas indicated by the symbol R13 in the layout selection icon L1 as illustrated in FIG. 11, the window W on which the drag operation was being made is arranged (snapped) in the display area in which the translucent box BX was displayed within the internal display (display 150) in FIG. 11.

Note that when plural windows are open, thumbnails of windows other than the window W on which the drag operation was being made may also be displayed in a display area(s) other than the display area in which the window W is arranged.

### [Configurations of Information Processing Apparatus]

Specific configurations of the information processing apparatus 10 will be described below.

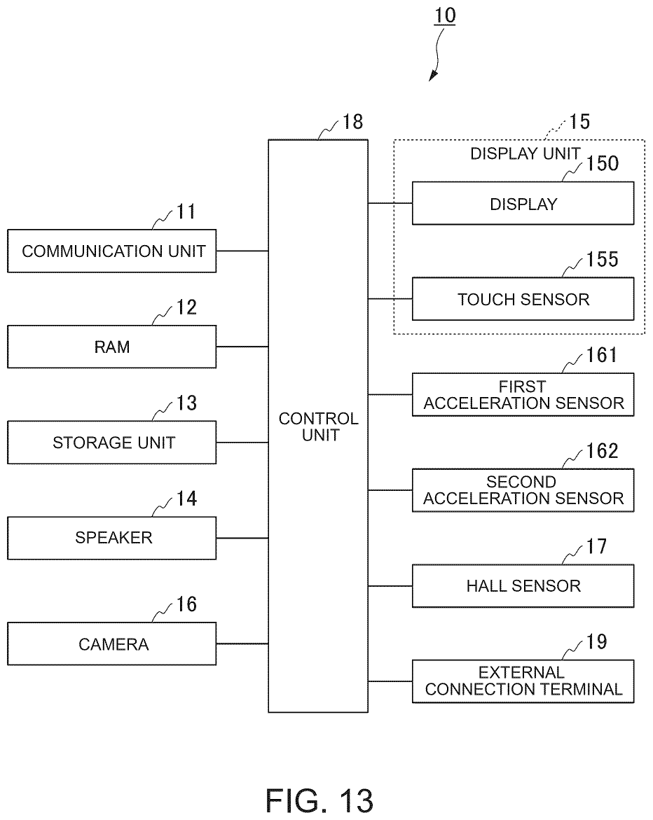

FIG. 13 is a block diagram illustrating an example of the hardware configuration of the information processing apparatus 10 according to one or more embodiments. The information processing apparatus 10 includes a communication unit 11, a RAM (Random Access Memory) 12, a storage unit 13, a speaker 14, a display unit 15, the camera 16, a first acceleration sensor 161, a second acceleration sensor 162, a Hall sensor 17, a control unit 18, and an external connection terminal 19. These units are communicably connected through a bus and the like.

The communication unit 11 is configured to include, for example, digital input/output ports such as two or more Ethernet (registered trademark) ports and two or more USB (Universal Serial Bus) ports, communication devices that perform wireless communication such as Bluetooth (registered trademark) and Wi-Fi (registered trademark), and the like. For example, the communication unit 11 can communicate with the above-described external keyboard 30 and the like using Bluetooth (registered trademark).

A program and data for processing executed by the control unit 18 are loaded into the RAM 12, and various data are stored or deleted appropriately. For example, the RAM 12 also functions as a display video memory (V-RAM) for providing a display on the display 150. As an example, the RAM 12 functions as a video memory for data to be displayed in each display area inside the screen area of the display 150 (or the display 250 when the external display device 20 is connected). Further, the RAM 12 stores information on running apps, information on an app currently in use (an app of the active window) among the running apps and on the other apps of inactive windows, and information indicating in which display area each window is displayed, on which layer the window is arranged, whether or not the size of the window is minimized, and the like. Note that since the RAM 12 is a volatile memory, no data is retained when power supply to the RAM 12 is stopped. Data that must be retained when the power supply to the RAM 12 is stopped is transferred to the storage unit 13.

The storage unit 13 is configured to include any one or more of an SSD (Solid State Drive), an HDD (Hard Disk Drive), a ROM (Read Only Memory), a Flash ROM, and the like. For example, in the storage unit 13, a BIOS (Basic Input Output System) program and configuration data, an OS (Operating System), programs of apps running on the os, various data used in the apps, and the like are stored.

The speaker 14 outputs electronic sound, voice, and the like.

The display unit 15 includes the display 150 and a touch sensor 155. As described above, the display 150 is a flexible display bendable according to the open angle θ by relative rotation of the first chassis 101 and the second chassis 102. The display 150 provides a display corresponding to each display mode described with reference to FIG. 4 under the control of the control unit 18. The touch sensor 155 is provided on the screen of the display 150 to detect a touch operation on the screen. For example, in the case of the one-screen mode, the touch sensor 155 detects a touch operation in the display area DA. Further, in the case of the two-screen mode, the touch sensor 155 detects a touch operation(s) in either or both of the first display area DA1 and the second display area DA2. A tap operation, a slide operation, a flick operation, a swipe operation, a pinch operation, and the like are included in touch operations. The touch sensor 155 detects a touch operation and outputs, to the control unit 18, operation information based on the detected operation.

The camera 16 is configured to include a lens, an image sensor, and the like. The camera 16 captures images (still images and moving images) and outputs data of the captured images under the control of the control unit 18.

The first acceleration sensor 161 is provided inside the first chassis 101 to detect the orientation of the first chassis 101 and a change in the orientation of the first chassis 101. For example, assuming that a direction parallel to the long-side direction of the first display area DA1 is X1 direction, a direction parallel to the short-side direction is Y1 direction, and a direction perpendicular to the X1 direction and the Y1 direction is Z1 direction, the first acceleration sensor 161 detects respective accelerations along the X1 direction, the Y1 direction, and the Z1 direction, and outputs the detection results to the control unit 18.

The second acceleration sensor 162 is provided inside the second chassis 102 to detect the orientation of the second chassis 102 and a change in the orientation of the second chassis 102. For example, assuming that a direction parallel to the long-side direction of the second display area DA2 is X2 direction, a direction parallel to the short-side direction is Y2 direction, and a direction perpendicular to the X2 direction and the Y2 direction is Z2 direction, the second acceleration sensor 162 detects respective accelerations along the X2 direction, the Y2 direction, and the Z2 direction, and outputs the detection results to the control unit 18.

The Hall sensor 17 is provided to detect the connection of the keyboard 30. For example, when the keyboard 30 is mounted on the second display area DA2 of the second chassis 102, the magnetic field changes by the approach of the magnets provided inside the bottom of the keyboard 30 to change a detection value (output value) of the Hall sensor 17. In other words, the Hall sensor 17 outputs a detection result varying depending on whether or not the keyboard 30 is mounted. Note that it is detected whether or not the keyboard 30 is mounted by using the Hall sensor 17 here, but the detection method is not limited thereto, and any other detection method can be used.

The external connection terminal 19 is a connection terminal for connecting to the external display device 20 (external display). For example, the external connection terminal 19 is an HDMI (registered trademark) terminal, a USB Type-C terminal, a display port, or the like. Note that the information processing apparatus 10 and the external display device 20 may also be connected wirelessly.

The control unit 18 is configured to include a processor such as a CPU (Central Processing Unit), a GPU (Graphic Processing Unit), or a microprocessor to realize various functions by executing programs (the BIOS, the OS, and various programs such as apps running on the OS) stored in the storage unit 13 and the like. For example, the control unit 18 detects the posture (orientation) of the information processing apparatus 10 based on the detection results of the first acceleration sensor 161 and the second acceleration sensor 162. Further, the control unit 18 detects whether the information processing apparatus 10 is in the open state or the closed state, whether the information processing apparatus 10 is in the bent state (Bent form) or the flat state (Flat form) in the case of the open state, and the like based on the detection results of the first acceleration sensor 161 and the second acceleration sensor 162.

Further, the control unit 18 detects the connection with the keyboard 30 based on the detection result of the Hall sensor 17. Note that this connection with the keyboard 30 indicates the mounting of the keyboard 30 on the second display area DA2, and does not indicate communication connection. The control unit 18 detects the communication connection with the keyboard 30 using the function of Bluetooth (registered trademark) or the like.

Further, the control unit 18 controls the first display switching function, the second display switching function, and the third display switching function to switch the position and size of a window inside the screen area according to predetermined rules. The control unit 18 uses a display switching function selected from among the first display switching function, the second display switching function, and the third display switching function to perform display change processing to change the arrangement of the window inside the screen area of the display 150 (internal display) or the display 250 (external display).

Further, the control unit 18 performs display state holding processing to hold the position and size of the window before being changed by the display change processing respectively for each of the first display switching function, the second display switching function, and the third display switching function. Further, when restoring at least either of the position and the size of the window changed using each of the first display switching function, the second display switching function, and the third display switching function, the control unit 18 performs display restoration processing to restore at least either of the position and the size of the window based on the position and size of the window held by using each display switching function.

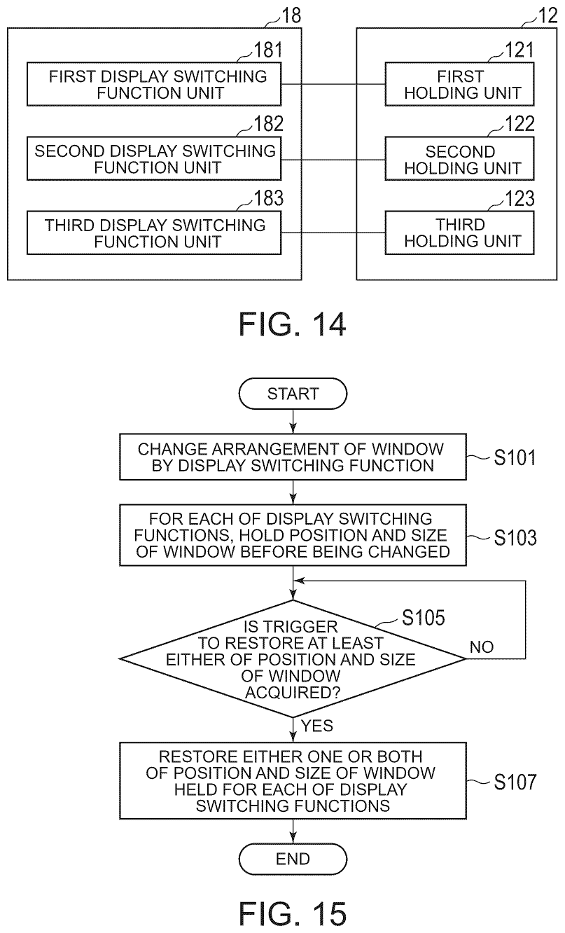

FIG. 14 is a block diagram illustrating an example of the functional configuration regarding the display switching functions of the information processing apparatus 10 according to one or more embodiments. The control unit 18 includes a first display switching function unit 181, a second display switching function unit 182, and a third display switching function unit 183 as functional components implemented by the CPU executing processing based on the OS, programs running on the OS, and the like.

The first display switching function unit 181 controls the first display switching function (see FIG. 4 and FIG. 5) to switch between the one-screen mode and the two-screen mode by detecting or determining the system state, the posture (orientation) of the information processing apparatus 10, whether the information processing apparatus 10 is in the open state or the closed state, and whether the information processing apparatus 10 is in the bent state (Bent form) or the flat state (Flat form) in the case of the open state. For example, the first display switching function unit 181 performs display change processing to change the window arrangement in the screen area depending on switching between the one-screen mode and the two-screen mode according to the predetermined rules for the first display switching function.

Further, the first display switching function unit 181 performs display state holding processing to hold, in a first holding unit 121, the position and size of a window before the arrangement thereof is changed by the display change processing of the first display switching function. The first holding unit 121 is, for example, a component included in the RAM 12. For example, when the arrangement of the window in the screen area is changed according to switching between the one-screen mode and the two-screen mode, the first display switching function unit 181 holds, in the first holding unit 121 (RAM 12), the position and size of the window before being changed.

Then, when restoring at least either of the position and the size of the window the arrangement of which was changed by the display change processing of the first display switching function, the first display switching function unit 181 performs display restoration processing to restore at least either of the position and the size of the window based on the position and size of the window held in the first holding unit 121. Here, a trigger upon restoration by the first display switching function is, for example, switching between the one-screen mode and the two-screen mode. For example, a trigger to restore at least either of the position and the size of the window the arrangement of which was changed according to switching from the one-screen mode to the two-screen mode is switching from the two-screen mode to the one-screen mode. Further, a trigger to restore at least either of the position and the size of the window the arrangement of which was changed according to switching from the two-screen mode to the one-screen mode is switching from the one-screen mode to the two-screen mode.

The second display switching function unit 182 controls the second display switching function (see FIG. 4 and FIGS. 6A-6B) to switch between the one-screen mode and the half-screen mode by detecting the connection with the keyboard 30. For example, according to predetermined rules for the second display switching function, the second display switching function unit 182 performs display change processing to change the arrangement of the window inside the screen area according to switching between the one-screen mode and the half-screen mode.

Further, the second display switching function unit 182 performs display state holding processing to hold, in a second holding unit 122, the position and size of the window before the arrangement of the window is changed by the display change processing of the second display switching function. The second holding unit 122 is, for example, a component included in the RAM 12. For example, when changing the arrangement of the window inside the screen area according to switching between the one-screen mode and the half-screen mode, the second display switching function unit 182 holds, in the second holding unit 122 (RAM 12), the position and size of the window before being changed.

Then, when restoring at least either of the position and the size of the window the arrangement of which was changed in the display change processing by the second display switching function, the second display switching function unit 182 performs display restoration processing to restore at least either of the position and the size of the window based on the position and size of the window held in the second holding unit 122. Here, a trigger upon restoration by the second display switching function is, for example, switching between the one-screen mode and the half-screen mode. For example, a trigger to restore at least either of the position and the size of the window the arrangement of which was changed according to switching from the one-screen mode to the half-screen mode is switching from the half-screen mode to the one-screen mode. Further, a trigger to restore at least either of the position and the size of the window the arrangement of which was changed according to switching from the half-screen mode to the one-screen mode is switching from the one-screen mode to the half-screen mode.

The third display switching function unit 183 controls the third display switching function (see FIG. 7A to FIG. 12) to rearrange (snap) a window, selected with a drag operation on the window being arranged in the screen area of the display 150, in any of display areas of a layout selectable from a layout selection icon. For example, according to predetermined rules for the third display switching function, the third display switching function unit 183 performs display change processing to change the arrangement of the window selected with the drag operation on the window.

Further, the third display switching function unit 183 performs display state holding processing to hold, in a third holding unit 123, the position and size of the window before the arrangement of the window is changed by the display change processing of the third display switching function. The third holding unit 123 is, for example, a component included in the RAM 12. For example, when changing the arrangement of the window inside the screen area according to the drag operation on the window, the third display switching function unit 183 holds, in the third holding unit 123 (RAM 12), the position and size of the window before being changed. Note that, when the external display is connected, information indicating whether the position of the window is on the internal display or the external display is also held.

Then, when restoring the size of the window the arrangement of which was changed by the display change processing of the third display switching function, the third display switching function unit 183 performs display restoration processing to restore the size of the window based on the size of the window held in the third holding unit 123. Here, in the third display switching function, since the position of the window is determined with a drag operation, only the size of the window is restored. A trigger when restoring the size of the window by the third display switching function is, for example, a drag (unsnap) operation on the window the arrangement of which was changed. For example, after the arrangement of the window inside the screen area is changed by the third display switching function according to the drag operation on the window, the trigger to restore the size of the window is when the drag operation on the window the arrangement of which was changed is started again, or when the drag operation is ended.

Referring next to FIG. 15, processing to change and restore the arrangement of the window by the first display switching function, the second display switching function, or the third display switching function will be described. FIG. 15 is a flowchart illustrating an example of processing by a display switching function according to one or more embodiments.

(Step S101) The control unit 18 uses a display switching function selected from among the first display switching function, the second display switching function, and the third display switching function to change the arrangement of the window inside the screen area of the display 150 (internal display) or the display 250 (external display). Then, the control unit 18 proceeds to a process in step S103.

(Step S103) The control unit 18 holds the position and size of the window before being changed by the display change processing in association with the display switching function selected in step S101. In other words, the control unit 18 holds the position and size of the window before being changed by each display change processing for each of the first display switching function, the second display switching function, and the third display switching function, respectively. Then the control unit 18 proceeds to a process in step S105.

(Step S105) The control unit 18 determines whether or not a trigger to restore at least either of the position and the size of the window changed in step S101 is acquired, and when determining that the trigger is acquired (YES), the control unit 18 proceeds to a process in step S107.

(Step S107) The control unit 18 restores at least either of the position and the size of the window based on the position and size of the window held in association with the display switching function selected in step S101. In other words, the control unit 18 restores either one or both of the position and the size of the window held by the display switching function selected in step S101 based on the position and size of the window held for each of the first display switching function, the second display switching function, and the third display switching function.

For example, in the case of the first display switching function or the second display switching function, the control unit 18 restores both of the position and the size of the window, while in the case of the third display switching function, the control unit 18 restores only the size of the window.

### SUMMARY OF EMBODIMENTS

As described above, the information processing apparatus 10 according to one or more embodiments includes the storage unit 13 (an example of a memory) which stores a program of an application, and the control unit 18 (an example of a processor such as a CPU, a GPU, or a microprocessor) which executes the program of the application stored in the storage unit 13 to perform control to display a window of the application in the screen area of the display 150 (or the display 250). The control unit 18 uses a display switching function selected from among plural display switching functions for switching the position and size of the window inside the screen area according to predetermined rules to perform display change processing to change the arrangement of the window inside the screen area, display state holding processing to hold, for each of the plural display switching functions, the position and size of the window before being changed by the display change processing, and display restoration processing in which, upon restoration of at least either of the position and the size of the window changed by the display change processing using each of the plural display switching functions, at least either of the position and the size of the window is restored based on the position and size of the window held by the display switching function used when performing the display change processing.

Thus, when there are plural display switching functions to appropriately change the position or the size of the window of the application in the screen area of the display 150 (or the display 250), the information processing apparatus 10 can avoid the functions to be influenced by one another when restoring the position or the size of the window.

For example, a first display switching function, a second display switching function, and a third display switching function are included in the plural display switching functions. The first display switching function is a display switching function by which, when rearranging the window being arranged in the screen area, switching whether to rearrange the window by setting the screen area as one display area or to rearrange the window by splitting the screen area into plural display areas is made. For example, the first display switching function is a display switching function to switch to the one-screen mode or to the two-screen mode. Note that, when splitting the screen area into the plural display areas, the screen area may also be split into three or more display areas without being limited to the two-screen mode to split the screen area into two display areas. The second display switching function is a display switching function by which, when rearranging the window being arranged in the screen area, switching whether to rearrange the window by setting the entire screen area as a display area or to rearrange the window by setting part of the screen area (for example, half of the screen area) as the display area is made. For example, the second display switching function is a display switching function to switch to the one-screen mode (full-screen mode) or to the half-screen mode. The third display switching function is a display switching function to switch on which layout predetermined in the screen area a window selected from among windows being arranged in the screen area of the display 150 is rearranged (for example, snapped). For example, at least two display switching functions among the first display switching function, the second display switching function, and the third display switching function may also be included in the plural display switching functions. Further, any other display switching function may be included in the plural display switching functions without being limited to the first display switching function, the second display switching function, and the third display switching function.

Thus, when restoring the position of the size of the window of the application after being changed by either of the first display switching function, the second display switching function, and the third display switching function described above, the information processing apparatus 10 can restore the position or the size of the window to the position or the size before being changed without being influenced by the functions other than the display switching function used to change the position or the size of the window.

Further, the information processing apparatus 10 includes a flexible display bendable as the display 150. Then, the first display switching function is a function capable of switching whether to rearrange the window using the screen area as one display area or to rearrange the window by splitting the screen area into plural display areas (for example, into two display areas) (i.e., the one-screen mode or the two-screen mode) depending on whether the display 150 is in a bent state or not.

Thus, the information processing apparatus 10 can switch, for example, between the one-screen mode and the two-screen mode depending on whether the display 150 is in the bent state or not to change the arrangement of the window properly according to each screen mode.

Further, the second display switching function is a function capable of switching whether to rearrange the window using the entire screen area as a display area or to rearrange the window using, as a display area, part of the screen area except for the area on which the keyboard 30 is mounted (i.e., the one-screen mode (the full-screen mode) or the half-screen mode) using, as a trigger, whether or not the physical keyboard 30 is mounted on the area as part of the screen area.

Thus, the information processing apparatus 10 can switch, for example, between the one-screen mode (the full-screen mode) and the half-screen mode depending on whether the keyboard 30 is mounted or not to change the arrangement of the window properly according to each screen mode.

Further, the third display switching function is a function capable of switching on which layer predetermined in the screen area a window selected from among windows being arranged in the screen area of the display 150 is rearranged.

Thus, the information processing apparatus 10 can rearrange any window in a desired position inside the screen area, for example, with a user drag operation.

Further, a control method for the information processing apparatus 10 according to one or more embodiments includes: a display change step of causing the control unit 18 (the example of a processor such as a CPU, a GPU, or a microprocessor) to change the arrangement of a window inside a screen area using a display switching function selected from among plural display switching functions to switch the position and size of the window inside the screen area of the display 150 (or the display 250) according to predetermined rules; a display state holding step of causing the control unit 18 to hold, for each of the plural display switching functions, the position and size of the window before being changed by the display change step; and a display restoration step in which, upon restoration of at least either of the position and the size of the window changed by the display change step using each of the plurality of display switching functions, the control unit 18 restores at least either of the position and the size of the window based on the position and size of the window held by the display switching function used when the display change step is performed.

Thus, the control method for the information processing apparatus 10 can avoid functions to be influenced by one another upon restoration of the position or the size of the window when there are plural functions to appropriately change the position or the size of the window of the application in the screen area of the display 150 (or the display 250).

While embodiments of this invention have been described in detail above with reference to the accompanying drawings, the specific configurations are not limited to those described above, and various design changes and the like can be made without departing from the scope of this invention. For example, the components described in the embodiments mentioned above may be combined arbitrarily.

Further, in the information processing apparatus 10 according to the embodiments described above, the bendable one display 150 is provided over the inner surface of the first chassis 101 and the inner surface of the second chassis 102, but the present invention is not limited thereto. For example, the information processing apparatus 10 may also be configured such that only the inner surface of the first chassis 101 is equipped with a display. Further, the information processing apparatus 10 may be configured such that displays are provided both on the inner surface of the first chassis 101 and the inner surface of the second chassis 102, respectively. No matter which configuration the information processing apparatus 10 has, the first display switching function, the second display switching function, or the third display switching function described above may also be applied.

Further, in the embodiments described above, the example in which the number of plural displays on each of which the information processing apparatus 10 performs control to provide a display is two, that is, the internal display of the information processing apparatus 10 and the external display of the external display device 20 is described, but the plural displays are not limited to this example. When the information processing apparatus 10 is equipped with two or more internal displays, the plural displays on each of which the information processing apparatus 10 performs control to provide a display may also be the two or more internal displays. Further, when the information processing apparatus 10 is connected with two or more external display devices 20, the plural displays on each of which the information processing apparatus 10 performs control to provide a display may be the two or more external displays, or may be the two or more external displays and one or more internal displays. In other words, the plural displays on each of which the information processing apparatus 10 performs control to provide a display may be two displays, or three or more displays, and these displays may be either the internal display or the external display.

Further, layouts selectable on the layout selection icon L1 or L2 (see FIGS. 7A-7B) in the embodiments described above are of three types, that is, the layout in which the entire screen area of the display 150 is set as one display area, the layout in which the screen area is split into two upper and lower parts or two left and right parts, and the layouts in which the screen area is split into three parts, but the layout types are not limited thereto. For example, only some of the above-mentioned three layout types may be selectable, or a layout in which the screen area is split into four or more parts may also be selectable.

Further, in the embodiments described above, the example of touch operations on the plural touch panel displays, each of which is configured to integrate an input unit (touch sensor) and a display unit, is described, but the display type is not limited to the type of touch panel displays.

Note that the information processing apparatus 10 described above has a computer system therein. Then, a program for implementing the function of each component included in the information processing apparatus 10 described above may be recorded on a computer-readable recording medium so that the program recorded on this recording medium is read into the computer system and executed to perform processing in each component included in the information processing apparatus 10 described above. Here, the fact that “the program recorded on the recording medium is read into the computer system and executed” includes installing the program on the computer system. It is assumed that the “computer system” here includes the OS and hardware such as peripheral devices and the like. Further, the “computer system” may also include two or more computers connected through networks including the Internet, WAN, LAN, and a communication line such as a dedicated line. Further, the “computer-readable recording medium” means a portable medium such as a flexible disk, a magneto-optical disk, a flash ROM, or a CD-ROM, or a storage device such as a hard disk built in the computer system. Thus, the recording medium with the program stored thereon may be a non-transitory recording medium such as the CD-ROM.

Further, a recording medium internally or externally provided to be accessible from a delivery server for delivering the program is included as the recording medium. Note that the program may be split into plural pieces, downloaded at different timings, respectively, and then united in each component included in the information processing apparatus 10, or delivery servers for delivering respective split pieces of the program may be different from one another. Further, it is assumed that the “computer-readable recording medium” includes a medium on which the program is held for a given length of time, such as a volatile memory (RAM) inside a computer system as a server or a client when the program is transmitted through a network. The above-mentioned program may also be to implement some of the functions described above. Further, the program may be a so-called a differential file (differential program) capable of implementing the above-described functions in combination with a program(s) already recorded in the computer system.

Further, some or all of the functions of the information processing apparatus 10 in the embodiments described above may be realized as an integrated circuit such as LSI (Large Scale Integration). Each function may be implemented by a processor individually, or some or all of the functions may be integrated as a processor. Further, the method of circuit integration is not limited to LSI, and it may be realized by a dedicated circuit or a general-purpose processor. Further, if integrated circuit technology replacing the LSI appears with the progress of semiconductor technology, an integrated circuit according to the technology may be used.

### DESCRIPTION OF SYMBOLS

10 information processing apparatus
101 first chassis
102 second chassis
103 hinge mechanism
11 communication unit
12 RAM
13 storage unit
14 speaker
15 display unit
16 camera
150 display
155 touch sensor
161 first acceleration sensor
162 second acceleration sensor
17 Hall sensor
18 control unit
19 external connection terminal
181 first display switching function unit
182 second display switching function unit
183 third display switching function unit
121 first holding unit
122 second holding unit
123 third holding unit

What is claimed is:

1. An information processing apparatus comprising:
a memory which stores a program of an application; and
a processor which executes the program of the application stored in the memory to perform control to display a window of the application in a screen area of a display,
wherein the processor performs
display change processing to change arrangement of the window inside the screen area using a display switching function selected from among a plurality of display switching functions to switch position and size of the window inside the screen area according to predetermined rules,
display state holding processing to hold, for each of the plurality of display switching functions, the position and size of the window before being changed by the display change processing, and
display restoration processing in which, upon restoration of at least either of the position and the size of the window changed by the display change processing using each of the plurality of display switching functions, at least either of the position and the size of the window is restored based on the position and size of the window held by the display switching function used when performing the display change processing.

2. The information processing apparatus according to claim 1, wherein among a first display switching function by which, when rearranging the window being arranged in the screen area, switching whether to rearrange the window by setting the screen area as one display area or to rearrange the window by splitting the screen area into a plurality of display areas is made, a second display switching function by which, when rearranging the window being arranged in the screen area, switching whether to rearrange the window by setting the entire screen area as a display area or to rearrange the window by setting part of the screen area as the display area is made, and a third display switching function to switch on which layout predetermined in the screen area a window selected from among windows being arranged in the screen area is rearranged, at least two display switching functions are included in the plurality of display switching functions.

3. The information processing apparatus according to claim 2, further comprising a bendable display as the display,
wherein the first display switching function is a function capable of switching whether to rearrange the window by setting the screen area as one display area or to rearrange the window by splitting the screen area into the plurality of display areas depending on whether the display is in a bent state or not.

4. The information processing apparatus according to claim 2, wherein the second display switching function is a function capable of switching whether to rearrange the window by setting the entire screen area as a display area or to rearrange the window by setting, as a display area, part of the screen area except for an area on which a physical keyboard is mounted using, as a trigger, whether or not the physical keyboard is mounted on the area as part of the screen area.

5. The information processing apparatus according to claim 2, wherein the third display switching function is a function capable of switching on which layout predetermined in the screen area the window selected from among the windows being arranged in the screen area is rearranged.

6. A control method for an information processing apparatus including: a memory which stores a program of an application; and a processor which executes the program of the application stored in the memory to perform control to display a window of the application in a screen area of a display, the control method comprising:
a display change step of causing the processor to change arrangement of the window inside the screen area using a display switching function selected from among a plurality of display switching functions to switch position and size of the window inside the screen area according to predetermined rules;
a display state holding step of causing the processor to hold, for each of the plurality of display switching functions, the position and size of the window before being changed by the display change step; and
a display restoration step in which, upon restoration of at least either of the position and the size of the window changed by the display change step using each of the plurality of display switching functions, the processor restores at least either of the position and the size of the window based on the position and size of the window held by the display switching function used when the display change step is performed.
